(19) United States
(12) Patent Application Publication
(10) Pub. No.: US 2012/0097349 A1
(43) Pub. Date: Apr. 26, 2012

(54) BLIND

(75) Inventor: Ju-Huai Chen, Changhua County (TW)

(73) Assignee: CHICOLOGY, INC., Ontario, CA (US)

(21) Appl. No.: 12/908,723

(22) Filed: Oct. 20, 2010

(51) Int. Cl. E06B 9/24

(52) U.S. Cl. 160/371

(57) ABSTRACT

A blind includes a blind body including a frame and a shade having an end disposed at an outer edge of the frame; a plurality of brake wheels movably disposed in the frame; and a limiting mechanism disposed at an end of the frame. The limiting mechanism includes a resilient element movably disposed in the frame; a winding reel movably disposed in the frame and positioned beside the resilient element; a cord reel movably disposed in the frame and driven by the winding reel; and a plurality of tractional cords coupled to the cord reel, passingly disposed at the brake wheels, and connected to the shade. Lifting or lowering of the shade is effectuated by the limiting mechanism and the brake wheels in conjunction with the external force exerted by the user, such that the blind is advantageously characterized by cordless control, ease of use, and enhanced user safety.

### FIELD OF THE INVENTION

The present invention relates to blinds, and more particularly, to a blind having a shade to be lifted or lowered as a result of an external force exerted thereon by a user, wherein the lifting or lowering of the shade is effectuated by a limiting mechanism and brake wheels in conjunction with the external force exerted by the user, such that the blind is advantageously characterized by cordless control, ease of use, and enhanced user safety.

### BACKGROUND OF THE INVENTION

A conventional blind (such as a Roman blind) comprises an upper beam, an elevating unit, and a shade coupled to the bottom of the upper beam. The elevating unit has a plurality of tractional cords and lifting cords. The shade comprises a plurality of slats. At least a hole is formed in each of the slats. The holes are lined up and penetrated by the lifting cords in a manner that the lifting cords are fixed to the lowest ones of the holes, respectively. To lift or lower the shade, a user pulls the tractional cords to thereby lift or lower the shade with the lifting cords.

The conventional blind has a drawback. The tractional cords are always found on one side of the shade. Toddlers are likely to put the tractional cords on their necks out of curiosity or during an inadvertent act committed in play. With a tractional cord on the neck, a toddler may end up in strangulation. Hence, tractional cords of the conventional blind pose a serious threat to child safety.

Accordingly, it is imperative to provide a blind advantageously characterized by cordless control, ease of use, and enhanced user safety.

### SUMMARY OF THE INVENTION

In view of the aforesaid drawbacks of a conventional blind, the inventor of the present invention believes that the conventional blind has room for improvement. Thus, the inventor of the present invention endeavors to improve the conventional blind from the inventor's experience of the related industry. Eventually, the inventor puts forth a blind advantageously characterized by cordless control, ease of use, and enhanced user safety.

It is a primary objective of the present invention to provide a blind having a shade to be lifted or lowered as a result of an external force exerted thereon by a user, wherein the lifting or lowering of the shade is effectuated by a limiting mechanism and brake wheels in conjunction with the external force exerted by the user, such that the blind is advantageously characterized by cordless control, ease of use, and enhanced user safety.

In order to achieve the above and other objectives, the present invention provides a blind comprising: a blind body comprising a frame and a shade having an end disposed at an outer edge of the frame; a plurality of brake wheels movably disposed in the frame; and a limiting mechanism disposed at an end of the frame, the limiting mechanism comprising: a resilient element movably disposed in the frame; a winding reel movably disposed in the frame and positioned beside the resilient element; a cord reel movably disposed in the frame and driven by the winding reel; and a plurality of tractional cords coupled to the cord reel, passingly disposed at the brake wheels, and connected to the shade.

In an embodiment of the present invention, a weight member is disposed at another end of the shade, and a tractional member is disposed at the weight member.

In an embodiment of the present invention, the brake wheels each comprise an axle coupled to the frame, a sleeve movably disposed around the axle, and a one-way spring disposed between the axle and the sleeve.

In an embodiment of the present invention, the resilient element has a spool formed with at least two grooves, and has constant force springs disposed in the grooves, respectively. The constant force springs each have an end disposed in a corresponding one of the grooves and another end coupled to the winding reel.

In an embodiment of the present invention, gear members which mesh are disposed on a side of the winding reel and the cord reel, respectively. In an embodiment of the present invention, a plurality of cord tracks are each provided on the cord reel to receive a corresponding one of the tractional cords.

Accordingly, the present invention provides a blind having a shade to be lifted or lowered as a result of an external force exerted thereon by a user, wherein the lifting or lowering of the shade is effectuated by a limiting mechanism and brake wheels in conjunction with the external force exerted by the user, such that the blind is advantageously characterized by cordless control, ease of use, and enhanced user safety.

### BRIEF DESCRIPTION OF THE DRAWINGS

A detailed description of the present invention is given below so that a person skilled in the art can fully understand the objectives, features, and advantages of the present invention by referring to the specific embodiments described hereunder in conjunction with the accompanying drawings, in which:

FIG. 1 is a perspective view of the present invention;

FIG. 2 is an exploded view of the present invention;

FIG. 3 is a schematic view of the working principle of the present invention; and

FIG. 4 is an enlarged exploded view of a brake wheel of the present invention.

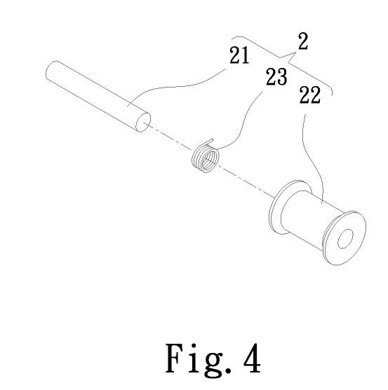

### DETAILED DESCRIPTION OF THE PREFERRED EMBODIMENTS

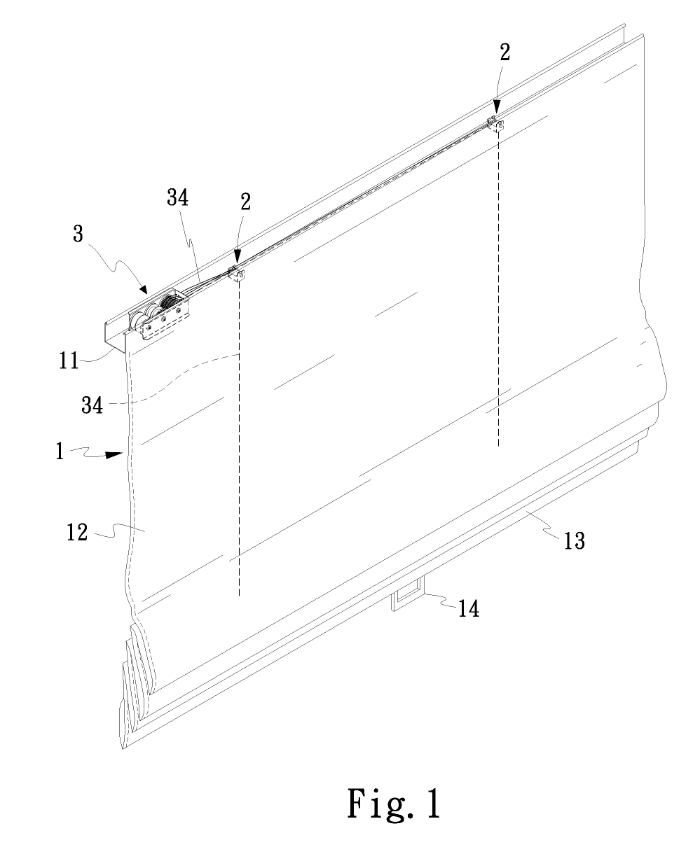

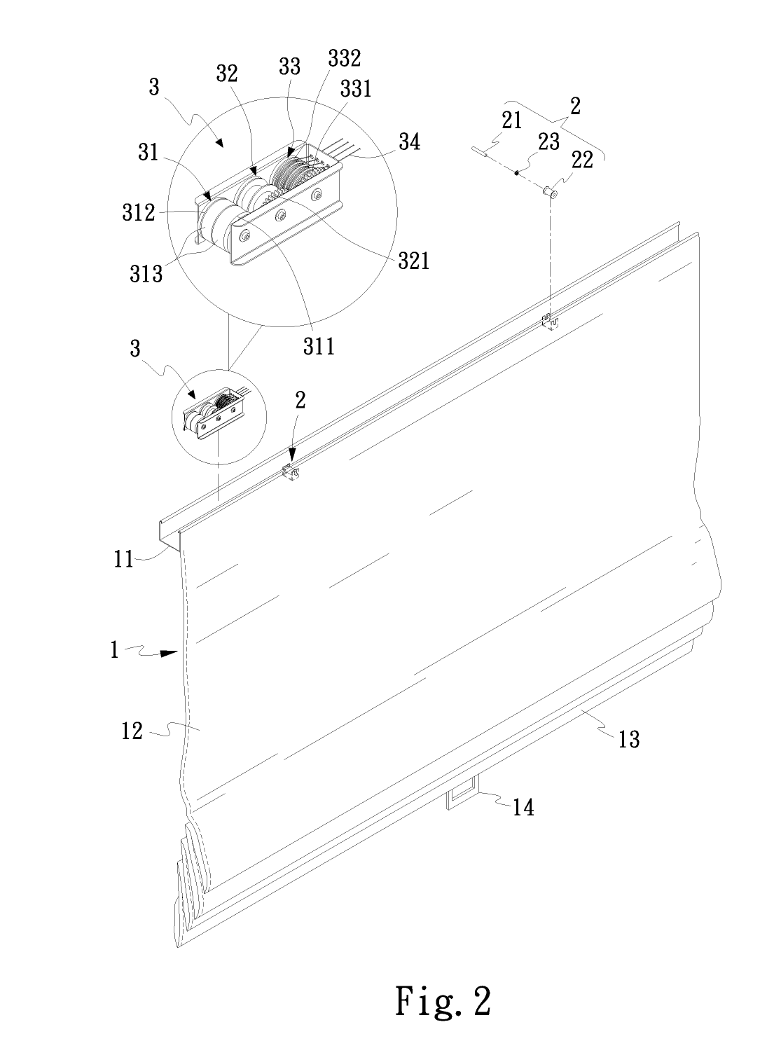

Please refer to FIG. 1 and FIG. 2 for a perspective view and an exploded view of the present invention, respectively. As shown in the drawings, the present invention provides a blind comprising a blind body 1, a plurality of brake wheels 2, and a limiting mechanism 3.

The blind body 1 comprises a frame 11 and a shade 12 having an end disposed at an outer edge of the frame 11. A weight member 13 is disposed at another end of the shade 12. A tractional member 14 is disposed at the weight member 13.

The brake wheels 2 are movably disposed in the frame 11. The brake wheels 2 each comprise an axle 21 coupled to the frame 11, a sleeve 22 movably disposed around the axle 21, and a one-way spring 23 disposed between the axle 21 and the sleeve 22.

The limiting mechanism 3 is disposed at an end of the frame 11. The limiting mechanism 3 comprises: a resilient element 31 movably disposed in the frame 11, a winding reel 32 movably disposed in the frame 11 and positioned beside the resilient element 31, a cord reel 33 movably disposed in the frame 11 and driven by the winding reel 32, and a plurality of fractional cords 34 coupled to the cord reel 33, passingly disposed at the brake wheels 2, and connected to the shade 12. The resilient element 31 has a spool 311 formed with at least two grooves 312, and has constant force springs 313 disposed in the grooves 312, respectively. The constant force springs 313 each have an end disposed in a corresponding one of the grooves 312 and another end coupled to the winding reel 32. Gear members 321, 331 which mesh are disposed on one side of the winding reel 32 and the cord reel 33, respectively. A plurality of cord tracks 332 are provided on the cord reel 33. The cord tracks 332 each receive a corresponding one of the tractional cords 34 winding around the sleeves 22 of the brake wheels 2.

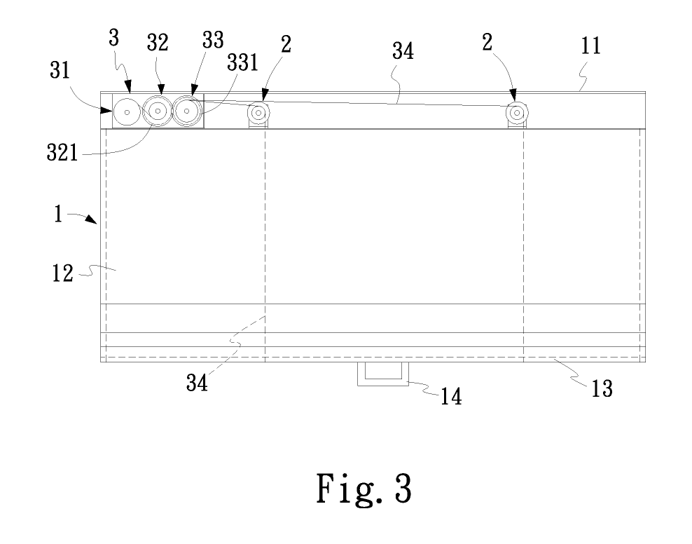

Please refer to FIG. 3 for a schematic view of the working principle of the present invention. As shown in the drawing, to install the blind of the present invention, (please refer to FIGS. 1 and 2 as well), it is feasible to fix the frame 11 of the blind body 1 above a window frame. To use the blind of the present invention, exert a downward external force on the tractional member 14 or the weight member 13 of the shade 12, such that the shade 12 drives the tractional cords 34 to rotate the cord reel 33; meanwhile, the force of rotation is transmitted from the gear member 331 disposed on one side of the cord reel 33 to the gear member 321 disposed on one side of the winding reel 32. As a result, the constant force springs 313 which are otherwise wound around the spool 311 are now wound around the winding reel 32. The tractional cords 34 drive the sleeves 22 of the brake wheels 2 to rotate, such that rotation of the sleeves 22 drives the one-way springs 23. Since the one-way springs 23 have a larger restoring force than the constant force springs 313 do, the one-way springs 23 prevent the sleeves 22 from rotating; hence, once the applied force exerted on the shade 12 vanishes, the one-way springs 23 will enable the shade 12 to stop moving and be fixed at the latest position of the application of applied forced exerted thereon.

To retract the shade 12, a user pushes the weight member 13 upward. The upward push counterbalances the restoring force of the one-way springs 23, such that the constant force springs 313 have a larger restoring force than the one-way springs 23 do. As a result, the constant force springs 313 are wound around the spool 311; meanwhile, the tractional cords 34 are increasingly wound around the cord reel 33. In so doing, the shade 12 is lifted readily, and thus the blind of the prevent invention dispenses with a tractional cord typical found on one side of the blind. Accordingly, the blind of the present invention is advantageously characterized by ease of use and enhanced user safety.

Hence, the present invention meets the three requirements of patentability, namely novelty, non-obviousness, and industrial applicability. Regarding novelty and non-obviousness, the shade of the present invention is lifted or lowered as a result of an external force exerted thereon by a user, wherein the lifting or lowering of the shade is effectuated by the limiting mechanism and the brake wheels in conjunction with the external force exerted by the user, such that the blind is advantageously characterized by cordless control, ease of use, and enhanced user safety. Regarding industrial applicability, products derived from the present invention meet market demands fully.

The foregoing preferred embodiments are provided to illustrate and disclose the present invention, and are not intended to be restrictive of the scope of the present invention. Hence, all equivalent modifications and replacement of the foregoing embodiments without departing from the spirit embodied in the disclosure of the present invention should fall within the scope of the present invention as set forth in the appended claims. Accordingly, the scope of the claims of the present invention should be defined by the appended claims.

What is claimed is:

1. A blind comprising:
a blind body comprising a frame and a shade having an end disposed at an outer edge of the frame;
a plurality of brake wheels movably disposed in the frame; and
a limiting mechanism disposed at an end of the frame, the limiting mechanism comprising: a resilient element movably disposed in the frame; a winding reel movably disposed in the frame and positioned beside the resilient element; a cord reel movably disposed in the frame and driven by the winding reel; and a plurality of tractional cords coupled to the cord reel, passingly disposed at the brake wheels, and connected to the shade.

2. The blind of claim 1, wherein a weight member is disposed at another end of the shade, and a tractional member is disposed at the weight member.

3. The blind of claim 1, wherein the brake wheels each comprise an axle coupled to the frame, a sleeve movably disposed around the axle, and a one-way spring disposed between the axle and the sleeve.

4. The blind of claim 1, wherein the resilient element has a spool formed with at least two grooves, and has constant force springs disposed in the grooves, respectively, the constant force springs each having an end disposed in a corresponding one of the grooves and another end coupled to the winding reel.

5. The blind of claim 1, wherein gear members which mesh are disposed on a side of the winding reel and the cord reel, respectively.

6. The blind of claim 1, wherein a plurality of cord tracks are provided on the cord reel, the cord tracks each receiving a corresponding one of the tractional cords.
